(19) United States
(12) Patent Application Publication
(10) Pub. No.: US 2019/0181755 A1
(43) Pub. Date: Jun. 13, 2019

(54) INDUCTORLESS DC TO DC CONVERTERS

(71) Applicant: Yaskawa America, Inc., Waukegan, IL (US)

(72) Inventor: Mahesh M. Swamy, Gurnee, IL (US)

(21) Appl. No.: 16/052,250

(22) Filed: Aug. 1, 2018

Related U.S. Application Data
(60) Provisional application No. 62/595,711, filed on Dec. 7, 2017.

(51) Int. Cl. H02M 3/158

(52) U.S. Cl. CPC H02M 3/158; H02M 3/1582

(57) ABSTRACT

An inductorless DC to DC converter comprises an input for connection to a DC supply and an output for connection to a DC load. A first capacitor is connected across one of the input and the output. A plurality of second capacitors are connected in series across the other of the input and the output. The first capacitor and the second capacitors are of equal capacitance. A plurality of switch circuits are provided, one for each second capacitor. Each switch circuit is connected across the first capacitor and one of the second capacitors. A control circuit controls operation of the plurality of switch circuits to momentarily place each second capacitor alternately across the first capacitor to transfer energy therebetween to selectively step-down or step-up voltage of the DC supply to the DC load.

### FIELD OF THE INVENTION

This application relates to DC to DC converters and, more particularly, to a DC to DC converter that does not employ any inductor as an intermediate energy storage element.

### BACKGROUND OF THE INVENTION

An advantage of AC power is that it can be easily transformed from one voltage level to another voltage level with the use of transformers. If the desired voltage is lower than the input voltage, then a step-down transformer is used. Conversely, if the desired voltage is higher than the input voltage, then a step-up transformer is used.

In AC systems, a transformer can be used to transform voltages from one level to another. If the secondary number of turns in a 1-phase AC transformer is lower than the primary number of turns, the transformer is referred to as a step-down transformer. If the secondary number of turns of the same AC transformer is higher than the primary number of turns, the transformer is referred to as a step-up transformer.

This type of ease is not afforded to DC voltages. When one wants to transform DC voltages from one voltage level to another, an intermediate storage element is needed in addition to an active switch to move the energy from the intermediate storage element to the load. The intermediate energy storage element is invariably an inductor. If the desired DC voltage is lower than the input DC voltage, then a buck converter is used and when the desired DC voltage is higher than the input DC voltage, a boost converter is used.

An advantage of the typical boost and buck converter is that it needs only one switch-diode combination and is relatively simple in power structure. However, there are many disadvantages. Both the boost and the buck configuration need an energy storage element in the form of an inductor. Due to DC current flowing through the inductor its core size is large. Due to high frequency switching typically involved in such configuration, there is significant power loss in the DC link inductor and the switch-diode configuration. At power levels of greater than 1 kW, typical efficiency achievable is 95% to 96%. There is audible noise in the energy storage element due to the high frequency switching. The switch and diode have to be rated to handle the highest voltage in the system and snubbers are typically needed to suppress the voltage spikes associated with stray inductance in the circuit. Finally, the switch-diode combination is rated for pull power operation since they process rated load power. In addition, the switch-diode combination need to be rated to handle the highest peak current in the system.

Inductorless DC to DC converters have been used in the power supply industry for quite some time. Midgly and Sigger introduced this idea originally in 1974—D. Midgly, and M. Sigger, “Switched Capacitors in Power Control”, Proceedings of the IEE, 121, July 1974, pp. 703-704. Due to lack of fast power switches and efficient components, the original circuits were not very efficient and had high ripple current flowing from the source to the load. In the 1980s, with the introduction of MOSFETs and ceramic capacitors, the overall switching topology improved in performance. Switches are used to connect capacitors in series or in parallel or in some combination of series and parallel structure to achieve both step-down and step-up operation. However, the original circuit configuration results in discontinuous current flow from the source. Such discontinuity in current flow causes the current to be chopped, resulting in high conducted EMI issue.

Another way of achieving a step-down operation using two capacitors in series was introduced in Umeno, K. Takahashi, I. Oota, F. Ueno, and T, Inoue, “New Switched Capacitor DC-DC Converter with Low Input Current Ripple and Its Hybridization”, 33rd IEEE Midwest Symposium on Circuits and Systems, August 1990, pp. 1091-1094. In the circuit shown therein, two capacitors are connected in series across the input. The value is deliberately chosen to be different. The load is across the second capacitor which is in series with the first capacitor. There is a third capacitor which is switched alternately so that at one time it appears across the first capacitor and in the next, it appears across the second capacitor. The charging time constant for a given value of load resistor is different and it depends on the values of the capacitors. Moreover, since the values are different, the instantaneous voltage across these capacitors is different and these capacitors thus have to be rated differently to handle the asymmetrical voltage stress. By controlling duration of the switched states for the third capacitor, the average voltage across the load can be controlled in a narrow band. For this to happen dynamically, a feedback signal and a controller is required.

The advantage of the DC to DC converter is that it does not have any magnetic components and hence has the potential of achieving high efficiency. Current ripple flowing from the input source can be minimized depending on the time duration of the states. Since the capacitors remain connected to the input source, depending on the time constant of the load, the input current can be made to be continuous for appropriate capacitance values. Some of the disadvantages are that voltage across the capacitors cannot be maintained to be equal on a cycle by cycle basis since the capacitances are different. A feedback control loop is needed to regulate the average output voltage in a narrow band. Since the instantaneous voltage across the capacitors is different, the layout of the circuit is important to reduce inductive transient voltage spikes that can happen during state changes. The arrangement of the switches is such that only step-down operation is possible. Bidirectional power flow is not possible.

Given the above facts, there is significant room for improvement. There have been many researchers who have worked in the area of switched DC to DC converters and many of them have been cited in a survey publication listed in reference M. Forouzesh, Y. P. Siwakoti, S. A. Gorji, F. Blaabjerg, and B. Lehman, “Step-up DC-DC Converters: A Comprehensive Review of Voltage-Boosting Techniques, Topologies, and Applications”, IEEE Transactions on Power Electronics, Vol. 32, No. 12, December 2017, pp. 9143-9178. However, there are still many unresolved issues.

The DC to DC converter described herein is a departure from the standard inductorless DC to DC converter topology and satisfies the requirements discussed above, in a novel and simple manner.

### SUMMARY OF THE INVENTION

This application describes a DC to DC converter that does not employ any inductor as an intermediate energy storage element. The DC to DC converter uses switches and diodes placed in appropriate manner to either buck the input voltage or boost the input voltage. Since charge is directly transferred from one capacitor to another, discrete voltage steps are achievable.

There is disclosed in accordance with one aspect a DC to DC converter comprising an input for connection to a DC supply and an output for connection to a DC load. A first capacitor is connected across one of the input and the output. A plurality of second capacitors are connected in series across the other of the input and the output. The first capacitor and the second capacitors are of equal capacitance. A plurality of switch circuits are provided, one for each second capacitor. Each switch circuit is connected across the first capacitor and one of the second capacitors. A control circuit controls operation of the plurality of switch circuits to momentarily place each second capacitor alternately across the first capacitor to transfer voltage therebetween to selectively step-down or step-up voltage of the DC supply to the DC load.

It is a feature that the converter comprises two second capacitors or three second capacitors.

It is another feature that the switch circuits comprise IGBTs.

It is an additional feature that the switch circuits comprise unidirectional switches wherein the control circuit selectively controls the switches to provide one of step-down or step-up configuration.

It is a further feature that the switch circuits comprise bidirectional switches wherein the control circuit selectively controls the switches to provide both step-down and step-up configuration.

There is disclosed in accordance with another aspect, a step-down DC to DC converter comprising an input for connection to a DC supply and an output for connection to a DC load. A first capacitor is connected across the output. A plurality of second capacitors are connected in series across the input. The first capacitor and the second capacitors are of equal capacitance. A plurality of switch circuits are provided, one for each second capacitor. Each switch circuit is connected across the first capacitor and one of the second capacitors. A control circuit controls operation of the plurality of switch circuits to momentarily place each second capacitor alternately across the first capacitor to facilitate energy transfer from the second capacitors to the first capacitor resulting in a step-down voltage mode of operation between the DC supply and the DC load.

It is a feature that the converter comprises two second capacitors to provide one-half step-down configuration. The switch circuits may comprise IGBTs with free-wheeling anti-parallel diodes.

It is another feature that the converter comprises three second capacitors to provide one-third step-down configuration. The switch circuits may comprise IGBTs.

There is disclosed in accordance with another aspect a step-up DC to DC converter comprising an input for connection to a DC supply and an output for connection to a DC load. A first capacitor is connected across the input. A plurality of second capacitors are connected in series across the output. The first capacitor and the second capacitors are of equal capacitance. A plurality of switch circuits are provided, one for each second capacitor. Each switch circuit is connected across the first capacitor and one of the second capacitors. A control circuit controls operation of the plurality of switch circuits to momentarily place each second capacitor alternately across the first capacitor to facilitate energy transfer from the first capacitor to the second capacitors resulting in a step-up voltage mode of operation between the DC supply and the DC load.

It is a feature that the converter comprises two second capacitors to provide step-up configuration having a gain of two. The switch circuits may comprise IGBTs with free-wheeling anti-parallel diodes.

It is another feature that the converter comprises three second capacitors to provide step-up configuration having a gain of three. The switch circuits may comprise IGBTs.

There is disclosed in accordance with another aspect a buck-boost DC to DC converter comprising an input for connection to one of a DC supply and a DC load and an output for connection to the other of the DC load and DC supply. A first capacitor is connected across the output. A plurality of second capacitors are connected in series across the input. The first capacitor and the second capacitors are of equal capacitance. A plurality of bidirectional switch circuits are provided, one for each second capacitor. Each bidirectional switch circuit is connected across the first capacitor and one of the second capacitors. A control circuit controls operation of the plurality of bidirectional switch circuits to momentarily place each second capacitor alternately across the first capacitor to facilitate energy transfer between the second capacitors and the first capacitor resulting in a buck-boost voltage mode of operation between the DC supply and the DC load.

It is a feature that the converter comprises two second capacitors to provide one-half step-down in buck operation or a gain of two in a boost operation.

It is another feature that the converter comprises three second capacitors to provide one-third step-down in buck operation or a gain of three in a boost operation.

It is a further feature that the switch circuits comprise IGBTs.

It is yet another feature that each bidirectional switch circuit comprises four switches, each switch comprising an IGBT with a free-wheeling anti-parallel diode.

Further features and advantages of the invention will be readily apparent from the specification and from the drawings.

### BRIEF DESCRIPTION OF THE DRAWINGS

FIG. 1 is an electrical schematic of a DC to DC converter in accordance with the invention providing one-half step-down mode of operation;

FIG. 2 is a timing diagram illustrating switching timing for switches of the circuit of FIG. 1;

FIGS. 3A and 3B illustrate configuration interpretations of the schematic of FIG. 1 according to which of the switches are alternately operated;

FIG. 4 is an electrical schematic of a DC to DC converter in accordance with the invention providing one-third step-down mode of operation;

FIG. 5 is a timing diagram illustrating suggested switch timing for the switches of FIG. 4;

FIGS. 6-8 comprise configuration interpretations of the circuit of FIG. 4 for alternately operating the three switch circuits of FIG. 4;

FIG. 9 is an electrical schematic of a DC to DC converter in accordance with the invention providing step-up configuration for a gain of two;

FIG. 10 is an electrical schematic of a DC to DC converter in accordance with the invention providing step-up configuration for a gain of three;

FIG. 11 is an electrical schematic of a buck-boost DC to DC converter in accordance with the invention for providing step-down and step-up configuration having two sections; and

FIG. 12 is an electrical schematic of a buck-boost DC to DC converter having three sections.

### DETAILED DESCRIPTION OF THE INVENTION

This application relates generally to a DC to DC converter that does not employ any inductor as an intermediate energy storage element.

To transform DC voltages from one voltage level to another, an intermediate storage element is typically needed in addition to an active switch to move the energy from the intermediate storage element to the load. The DC to DC converter disclosed herein is different from the norm. It does away with the intermediate storage element stage. Charge is transferred from one capacitor to another using a series of switches. In one aspect, the switches can be used in a bidirectional way such that they can be used to either buck the input voltage or boost the input voltage.

The concept is first discussed for a buck operation. In the case of a buck converter, the output voltage is lower than the input voltage. The converter is configured to move charge from a higher voltage capacitor to a lower voltage capacitor using switches and diodes. Moving charge from one capacitor to another using switches and diodes without using any intervening magnetic circuit is the basic underlying principal in switched capacitor DC to DC converters. Unlike the schemes that have intermediate energy storage element in the form of an inductor, one cannot achieve fine regulation in the switched capacitor schemes. Since the output is a fixed ratio of the input, the scheme described herein does not need any feedback circuit to regulate the load voltage.

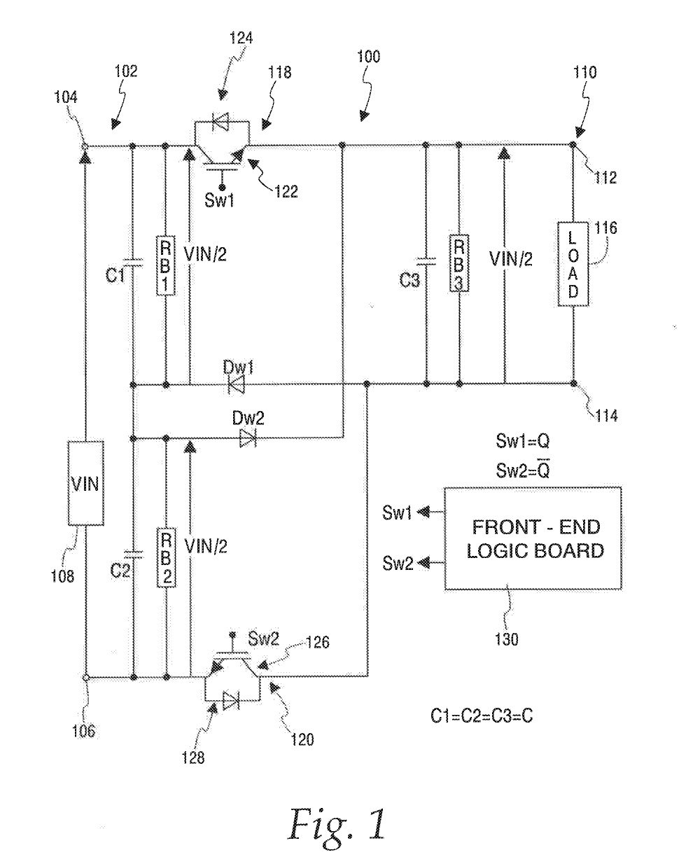

Referring initially to FIG. 1, a step-down DC to DC converter 100 provides a one-half step-down mode of operation. The converter 100 includes an input 102 defined by nodes 104 and 106 for connection to a DC supply 108 supplying input voltage VIN. An output 110 is represented by a positive terminal 112 and a return terminal 114 for connection to a DC load 116. As described above, the DC to DC converter 100 does not employ any inductor as an intermediate energy storage element. Instead, voltage is transferred between capacitors, as described below.

The converter 100 includes a first capacitor C3 connected across the output 110. A pair of second capacitors C1 and C2 are connected in series across the input 102. The capacitors C1, C2 and C3 are equal capacitance value and rated for the same voltage. A bleed resistor RB1 is connected across the capacitor C1. A bleed resistor RB2 is connected across the capacitor C2. A bleed resistor RB3 is connected across the capacitor C3. Each of the bleed resistors are of equal resistance. A pair of switch circuits 118 and 120, one for each second capacitor C1 and C2, respectively, are provided. The first switch circuit 118 is connected across the capacitor C3 and the capacitor C1. The second switch circuit 120 is connected across the capacitor C3 and the capacitor C2. The first switch circuit 118 comprises a first switch Sw1 and a first diode Dw1. The second switch circuit 120 comprises a second switch Sw2 and a second diode Dw2. The first switch Sw1 comprises an IGBT 122 with a free-wheeling anti-parallel diode 124. The collector of the IGBT 122 is connected to the input terminal 104 and the positive side of the capacitor C1. The emitter of the IGBT 122 is connected to the positive side of the capacitor C3 and the output positive terminal 112. The cathode of the diode Dw1 is connected to the junction of the capacitors C1 and C2. The anode of the diode Dw1 is connected to the return terminal 114.

The second switch Sw2 comprises an IGBT 126 and a free-wheeling anti-parallel diode 128. The emitter of the IGBT 126 is connected to the input terminal 106, while its collector is connected to the return terminal 114. The anode of the diode Dw2 is connected to the junction of the capacitors C1 and C2, while its cathode is connected to the output positive terminal 112.

The switches Sw1 and Sw2 are operated by a front-end logic board 130 having outputs connected to the first switch Sw1 and the second switch Sw2 which are configured so that when one is on, the other is off.

In the illustrated embodiment, the IGBTs 122 and 126 have a free-wheeling diode 124 and 128, respectively, associated therewith. As will be apparent, an IGBT or any other power semiconductor device could be used for the switches Sw1 and Sw2 with or without the anti-parallel free-wheeling diodes.

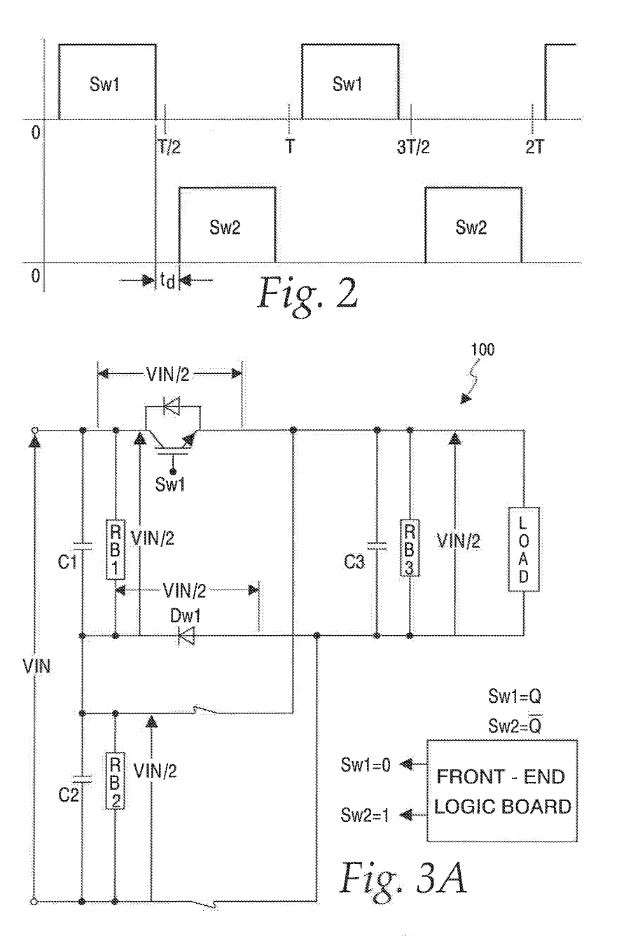

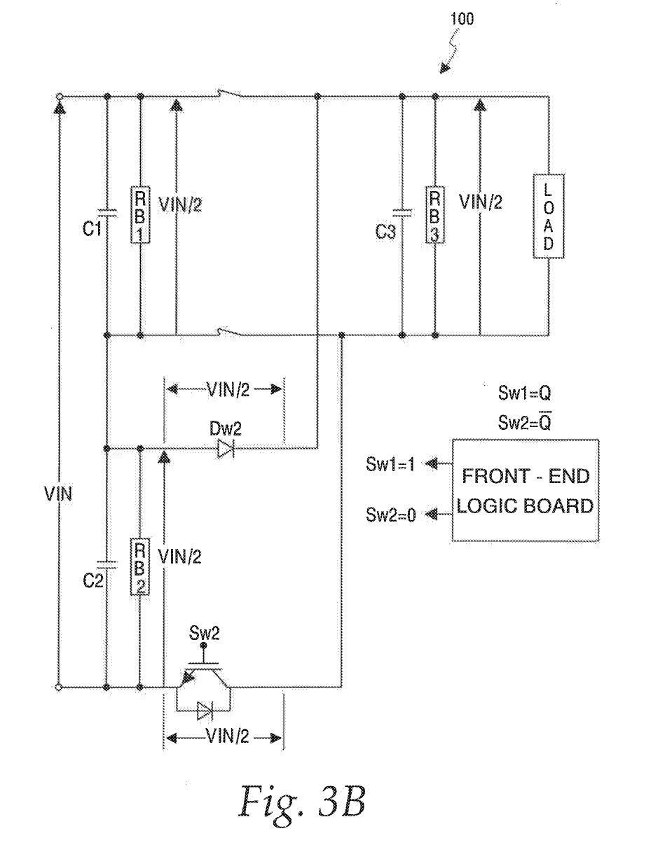

The switching scheme for the circuit of FIG. 1 is straight forward. Sw1 and Sw2 are turned ON and OFF alternately. When Sw1 is ON, Sw2 is OFF (see FIG. 3B), and when Sw1 is OFF, Sw2 is ON (see FIG. 3A). A minor dead time is included between the two sets of switching. The preferred switching times are shown in FIG. 2. The duty cycle can be lower but since the described scheme involves transferring energy between capacitors, the output voltage cannot be reduced below VIN/2. The output voltage is always equal to the voltage across each of the second capacitors C1 and C2. Since there are two capacitors in series in the example being discussed, the only voltage possible at the output is VIN/2. If the main input voltage, VIN, is divided into three or four capacitors in series, then the by extending the logic described, one could achieve an output voltage of VIN/3 for the case with three capacitors in series and VIN/4 for the case with four capacitors in series.

Though the output voltage is not variable, there are many applications that require reducing the DC voltage by discrete steps. Such a high level of attenuation (50% for two capacitors, 66.6% for three capacitors, 75% for four capacitors, etc.) without the use of any energy storage element in the form of a DC inductor is a significant advantage. A suggested switching scheme for the case with two capacitors in series is shown in FIG. 2.

Based on the switching pattern described above, the voltage rating of the switches can be easily determined. When switch Sw2 is ON, the voltage across Sw1, which is in the OFF state, is equal to VIN/2 since the mid-point of the input voltage appears at the emitter of Sw1. Similarly, the voltage across Sw2 will be VIN/2 since the mid-point of the input voltage will appear at the collector of Sw2. This visualization is shown in FIG. 3A.

FIG. 3A shows that the maximum voltage across the non-conducting switch-diode combination is one-half of the input voltage (VIN/2). The maximum current flowing through the switch is equal to the load current since the load current flows through the switch. Since the effective duty cycle is 0.5, the average current through the switch can be said to be half of the rated load current. In other words, ISw(AVG)=IRATED/2, where IRATED is the rated load current. However, while selecting components, maximum rating needs to be used and not the average value. Based on this, the VA rating of the switch is computed as follows:

$$VA = {V}_{MAX} \times {I}_{MAX} = \frac{{V}_{IN}}{2} \times {I}_{RATED} = \frac{{V}_{IN} \times {I}_{RATED}}{2} = {V}_{OUT} \times {I}_{RATED} = {P}_{RATED} \qquad ( 1 )$$

From eq. (1), it can be seen that the VA rating of the switch is same as that of the total power rating of the load. Since there are two switches, the combined maximum VA rating of the semiconductor switches in the proposed topology is 2×P_{RATED}.

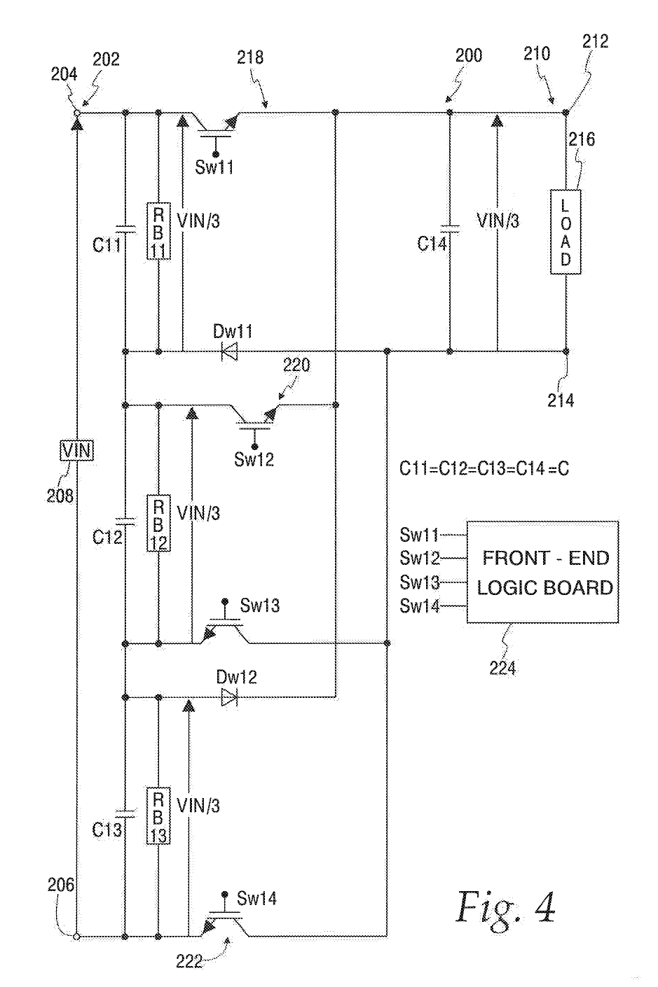

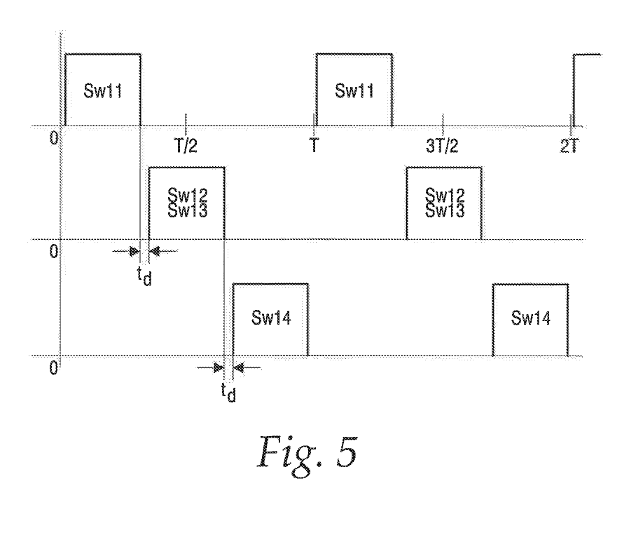

As described above, the basic idea shown in FIG. 1 can be extended by adding more capacitor sections on the input. If the input has three capacitors of equal value in series that divide the input voltage VIN into three equal values of VIN/3, then by the output voltage of VIN/3 can be achieved. Such a scheme is shown in FIG. 4. The corresponding switching scheme for the six switches is shown in FIG. 5.

Particularly, FIG. 4 is an electrical schematic of a step-down DC to DC converter 200 providing one-third step-down mode of operation. An input 202 represented by nodes 204 and 206 is provided for connection to a DC supply 208. An output 210 is represented by a positive terminal 212 and a return terminal 214 for connection to a DC load 216.

A first capacitor C14 is connected across the load 216. Three second capacitors C11, C12 and C13 are connected in series across the input 202. The capacitors C11-C14 are of equal capacitance value and equal rating. The second capacitors C11, C12 and C13 include respective bleed resistors RB11, RB12 and RB13 in parallel. Three switch circuits 218, 220 and 222 are each connected across the first capacitor C14 and the respective second capacitors C11, C12 and C13. The first switch circuit 218 comprises a switch Sw11 and diode Dw11. The second switch circuit 220 comprises two switches Sw12 and Sw13. The third switch circuit 222 comprises a diode Dw12 and a switch Sw14. Each of the switches Sw11-Sw14 comprises an IGBT or other power transistor. These switches Sw11-Sw14 should not have anti-parallel free-wheeling diodes associated therewith.

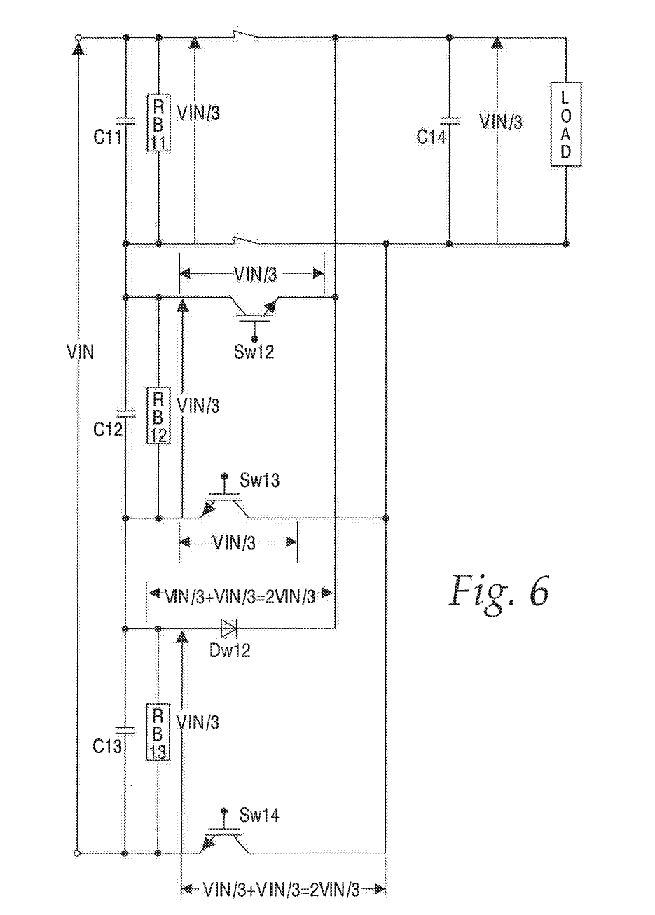

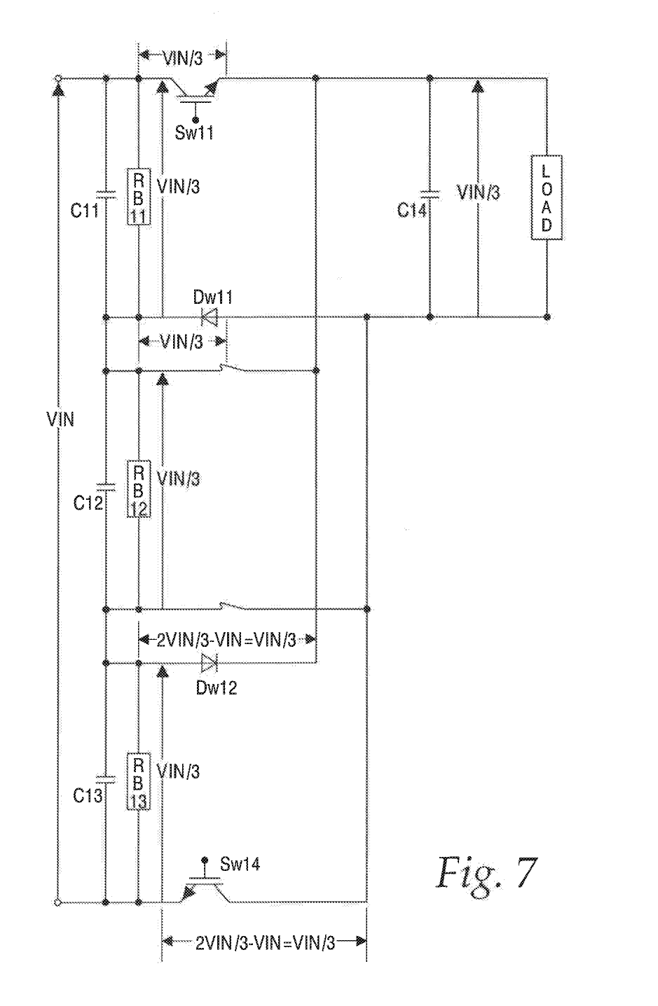

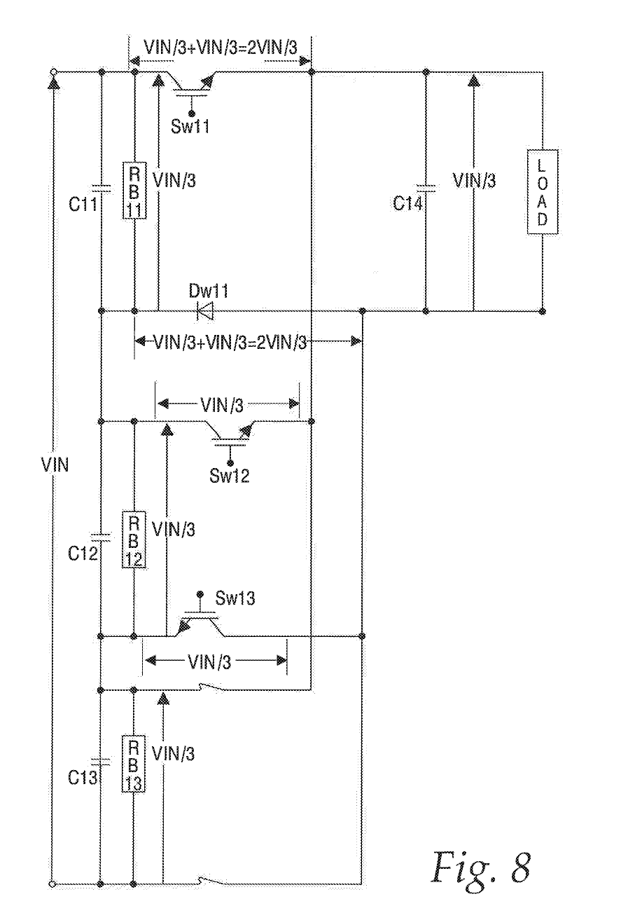

A front-end logic board 224 controls the switches Sw11-Sw14 in accordance with the timing pattern illustrated in FIG. 5. FIG. 6 illustrates the configuration interpretation when the first switch circuit 218 is turned on. FIG. 7 illustrates the configuration interpretation when the second switch circuit 220 is turned on. Finally, FIG. 8 illustrates the configuration interpretation when the third switch circuit 222 is turned on.

Based on the switching pattern suggested in FIG. 5, the voltage rating of the switches can be determined. For this configuration where the number of sections is odd, the voltage rating of the switches depends on the particular section under consideration as described below.

When the switch in the first section 218, namely Sw11 is ON, the voltage across Sw12 and Sw13 will be equal to VIN/3 as explained here. Turning on Sw1 connects the emitter of Sw12 to the positive of C11 while the collector of Sw12 remains connected to the negative of C11 and hence the voltage across Sw12 can be seen to be VIN/3.

Similarly, conduction of Dw11 connects the collector of Sw13 to the negative of C11 (also positive of C12), while the emitter of Sw13 remains connected to the negative of C12. Hence, the voltage across the Sw14-Dw14 combination can be seen to be VIN/3.

However, the voltage across Sw14 and Dw12 is seen to be much different as explained here. Turning on Sw11 connects the positive of C11 to the cathode of Dw12. The anode of Dw12 remains connected to the negative of C12 (also positive of C13). The total voltage of the string that consists of C11 and C12 in series is 2VIN/3 and so the voltage across Dw12 is seen to be 2VIN/3.

Similarly, the conduction of Dw11 connects the collector of Sw14 to the positive of C12 (also negative of C11), while the emitter of Sw14 remains connected to the negative of C13. Hence, the voltage across Sw14 can be seen to the voltage across the combination of C12 and C13, which is 2VIN/3.

The visualization of the above description is shown via the schematic in FIG. 6.

When the switches in the second section 220, namely Sw12 and Sw13 are ON, the voltage across Sw11 and Dw11 will be equal to VIN/3 as explained here. Turning ON Sw12 connects the emitter of Sw11 to the negative of C11 while the collector remains connected to the positive of C11 and so the voltage across Sw11 is seen to be Vin/3. Similarly, when Sw12 is ON, the cathode of Dw12 is connected to the positive of C12 while its anode remains connected to the negative of C12 and so the voltage across Dw12 is Vin/3.

Turning ON Sw13 connects the anode of Dw11 to the negative of C12 while the cathode of Dw11 remains connected to the positive of C12 and hence the voltage across Dw11 is seen to be VIN/3. Turning ON of Sw13 also connects the collector of Sw14 to the positive of C13 while its emitter remains connected to the negative of C13. Hence, the voltage across Sw14 is VIN/3 when Sw13 is turned ON.

The visualization of the above description is shown via a schematic in FIG. 7.

When the switch and diode combination in the third section 222, namely Dw12 and Sw14 are ON, the voltage across Sw11 and Dw11 will be equal to 2VIN/3 as explained here. Turning on Dw12 connects the emitter of Sw11 to the negative of C12 (also positive of C13) while the collector of Sw11 remains connected to the positive of C11 and hence the voltage across Sw11 is the series of the voltages across C11 and C12, which is 2VIN/3.

Similarly, turning ON Sw14 connects the anode of Dw1 to the negative of C13, while its cathode remains connected to the positive of C12. Hence, the voltage across Dw11 is the voltage across the series combination of C12 and C13, which is 2VIN/3.

The voltage across Sw12 and Sw13 is seen to be VIN/3 as explained here. Turning on Dw12 connects the positive of C13 (also negative of C12) to the emitter of Sw13. The collector of Sw13 remains connected to the positive of C12. Hence the voltage across the Sw13 is that across C12, which is equal to VIN/3. Similarly turning on Sw14 connects the negative of C13 to the collector of Sw13 while the emitter of Sw13 remains connected to the positive of C13. Hence, the voltage across Sw13 is that of the voltage across C13, which is VIN/3.

The visualization of the above description is shown via a schematic in FIG. 8.

From FIGS. 6-8, one can compute the VA rating of each switch and eventually that of the complete structure for the case when 66.6% attenuation is sought. Though the voltage rating of the switches depends on whether they are used in the second section 220 or in the third section 222, the maximum current flowing through the switch is equal to the load current since the load current flows through the switch.

Since the effective duty cycle is 0.33, the average current through the switch can be said to be one-third (⅓) of the rated load current. In other words, ISw(AVG)=I_{RATED}/3, where I_{RATED} is the rated load current. However, while selecting components, maximum rating needs to be used and not the average value. Based on this, the VA rating of each section is computed independently and then combined to get the total VA rating of all the switches. The output voltage VOUT is equal to VIN/3.

$$\begin{matrix}{VA}_{SECTION 1} = {V}_{MAX} \times {I}_{MAX} \\ = \frac{2 {V}_{IN}}{3} \times {I}_{RATED} \\ = \frac{2 \times {V}_{IN} \times {I}_{RATED}}{3} \\ = 2 \times {V}_{OUT} \times {I}_{RATED} \\ = 2 \times {P}_{RATED}\end{matrix}$$

$$\begin{matrix}{VA}_{SECTION 2} = {V}_{MAX} \times {I}_{MAX} \\ = \frac{{V}_{IN}}{3} \times {I}_{RATED} \\ = \frac{{V}_{IN} \times {I}_{RATED}}{3} \\ = {V}_{OUT} \times {I}_{RATED} \\ = {P}_{RATED}\end{matrix}$$

Since there are two switches in section 220, the total VA rating of the switches in section 220 will be 2×P_{RATED}.

$$\begin{matrix}{VA}_{SECTION 3} = {V}_{MAX} \times {I}_{MAX} \\ = \frac{2 {V}_{IN}}{3} \times {I}_{RATED} \\ = 2 \times {V}_{OUT} \times {I}_{RATED} \\ = 2 \times {P}_{RATED}\end{matrix} \\ {VA}_{TOTAL} = {VA}_{SECTION 1} + {VA}_{SECTION 2} + {VA}_{SECTION 3} = 6 \times {P}_{RATED} \qquad ( 2 )$$

From eq. (2), it can be seen that the combined VA rating of the complete structure is six times the total power rating of the load.

Based on the results presented in the preceding sections, one can generalize the combined VA rating of the switches and draw other conclusions.

From the above discussions, the maximum voltage across any given switch depends on the number of sections used. For even number of sections, it is VIN(2p−1)/2p where p is any positive integer. For odd number of sections, it is ((p−1)/p)×VIN where p is an odd integer greater than or equal to 3. In all cases, the higher the number of sections, the closer is the maximum switch voltage to the input voltage and the converter is less desirable.

Since the number of switches used in the proposed topology is always (2n−2) where n is the number of sections, greater than 1, either odd or even, it is impractical to adopt this topology for n greater than 3. In the preferred embodiment, n is at least two and not greater than three.

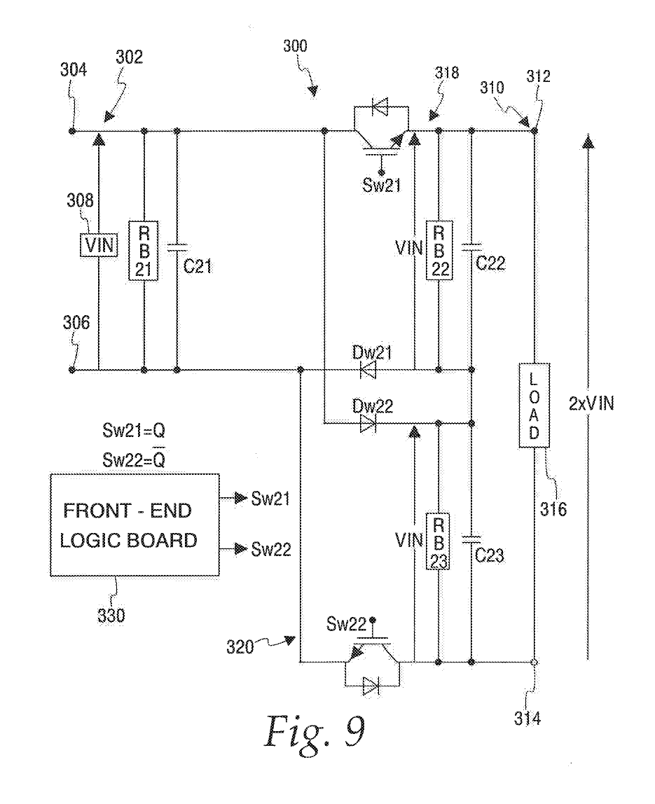

FIG. 9 illustrates an electrical schematic for a step-up DC converter 300 configured for achieving a gain of two. An input 302 includes nodes 304 and 306 for connection to a DC supply 308. An output 310 has a positive terminal 312 and a return terminal 314 for connection to a DC load 316. A first capacitor C21 and bleed resistor RB 21 are connected across the input 302. A pair of second capacitors C22 and C23 are connected in series across the output 310. Bleed resistors RB22 and RB23 are across the respective second capacitors C22 and C23. The capacitors C21, C22 and C23 are of equal capacitance value and equal rating. A first switch circuit 318 is connected across the capacitor C21 and the capacitor C22. A second switch circuit 320 is connected across the capacitor C21 and the capacitor C23. The first switch circuit 318 comprises a switch Sw21 and diode Dw21. The second switch circuit 320 comprises a switch Sw22 and diode Dw22. The switches Sw21 and Sw22 in the illustrated embodiment comprise IGBTs with free-wheeling anti-parallel diodes. As above, the IGBTs or other power semi-conductor switches may or may not have the anti-parallel free-wheeling diodes.

Control of the switch circuits 318 and 320 is provided by a front-end logic board 330 for controlling the switches Sw21 and Sw22.

The advantage of the step-up converter 300 is that by interchanging the diode and switch arrangements in an appropriate manner, one can achieve step-up mode of operation where a low voltage source can be effortlessly stepped up to feed a higher voltage load. The preferred embodiment for achieving a gain of two is shown in FIG. 9. Similar to the step-down mode of operation, the system does not need any feedback circuit to regulate the load voltage. Discrete step-up voltage is provided.

Under no-load condition, with the described arrangement, the voltage across each capacitor will be VIN. If a load is connected across the series combination of the two second capacitors C22 and C23, it will experience an overall voltage across it of 2×VIN. If sharing of voltage is unequal, it is not possible to achieve 2×VIN across the load 316. However, if the charge from the input or first capacitor C21 is placed for equal time on the second capacitors C22 and C23, one by one, then each of the load capacitors C22 and C23 will be charged to VIN and the overall voltage across the series combination of the two capacitors and hence across the load 316 will be 2×VIN. The main problem can then be stated as a problem of equally distributing the available energy source across C21 to capacitors C22 and C23 respectively. The load voltage can then be held constant at 2×VIN with each load capacitor (C22 and C23) holding the same amount of charge and hence the same voltage. Such a dynamic distribution of capacitor charge is facilitated by using switch diode configuration that momentary places the source capacitor alternately across each of the two load side capacitors connected in series as shown in FIG. 9.

The switching scheme for the circuit of FIG. 9 is the same as that shown in FIG. 2 and so is not repeated here (recognizing the different switch designator, such as Sw21 rather than Sw1, etc). When Sw21 is ON, Sw22 is OFF, and when Sw21 is OFF, Sw22 is ON. The voltage across each of the capacitors C21-C23 is the same and this is achieved by using the switching scheme shown in FIG. 2. Since the load 316 is across two capacitors C22 and C23 in series, the total voltage across the load will be 2×VIN.

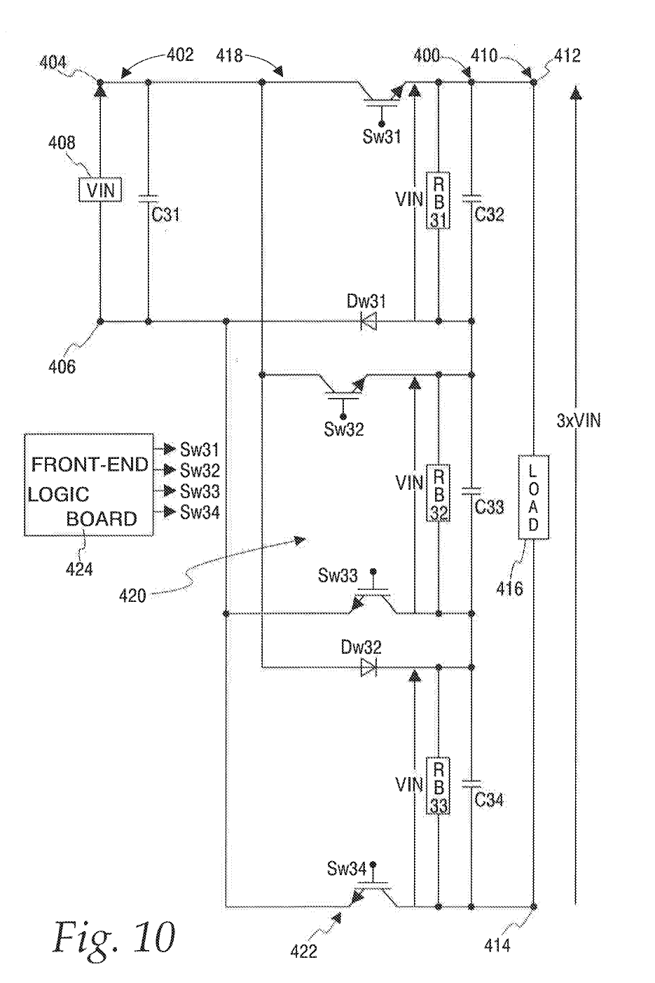

If the load side comprises three capacitors of equal value in series, using a similar scheme as that shown in FIG. 9 with an additional set of switch-diode combination, the load voltage can be increased to 3×VIN as shown with the step-up DC to DC converter 400 in FIG. 10. The switching scheme for the six switches in FIG. 10 is the same as that for its buck counterpart and is shown FIG. 5.

The DC to DC converter 400 provides step-up configuration with a gain of three. The converter includes an input 402 represented by nodes 404 and 406 for connection to a DC supply 408. An output 410 comprises a positive terminal 412 and return terminal 414 for connection to a load 416. A first capacitor C31 is connected across the input 402. Three second capacitors C32, C33 and C34 are connected across the output 410, each including an associated bleed resistor RB31, RB32 and RB33, respectively. A first switch circuit 418 comprises a switch Sw31 and diode Dw31. A second switch circuit 420 comprises a pair of switches Sw32 and Sw33. A third switch circuit 422 comprises a diode Dw32 and switch Sw34. These are controlled by a control circuit 424, comprising a front-end logic board, for the switches Sw31-Sw34 using a pattern similar to that in FIG. 5.

Because the components and concept in FIG. 10 are similar to those discussed above, they are not otherwise described in detail herein.

Similar to the observations made in the buck mode of operation, structures that have more than three sections are not practical. The preferred number of sections is two for the structure to be economically relevant.

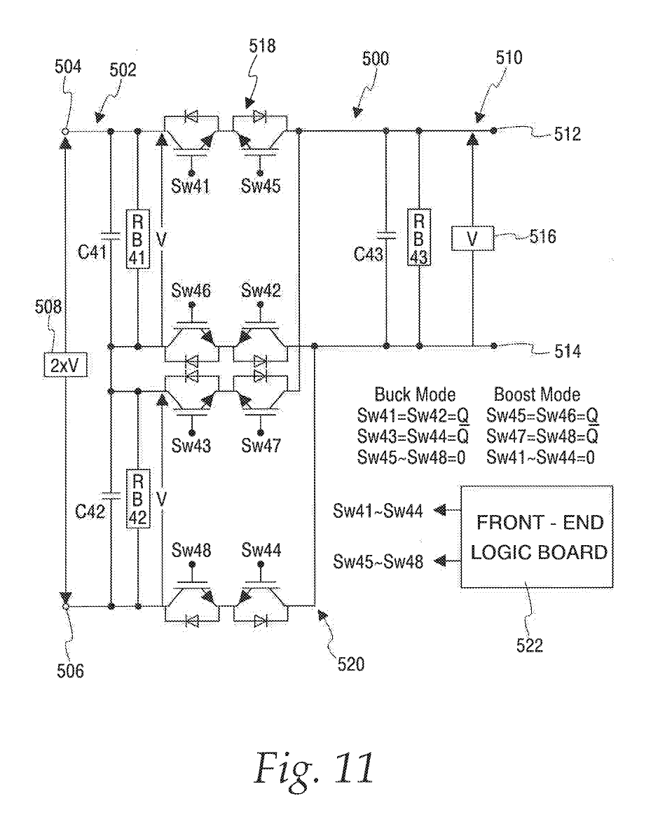

By changing the switches from unidirectional to bidirectional, one can achieve a buck-boost operation simply by selecting the correct switch set to be turned ON and OFF. Such a buck-boost structure is discussed next and is shown in FIG. 11. Similar to both the step-down and step-up modes of operation, the system does not need any feedback circuit to regulate the load voltage.

Referring to FIG. 11, a buck-boost DC to DC converter 500 is illustrated. The converter 500 includes an input 502 having nodes 504 and 506 for connection to a block 508. An output 510 comprises a positive terminal 512 and return terminal 514 for connection to a block 516. The blocks 508 and 516 each represent one of a DC supply and a DC load, depending on the desired operation, as discussed below.

A first capacitor C43 is connected across the output 510. A pair of second capacitors C41 and C42 are connected in series across the input 502. As with the converter of FIG. 1, bleed resistors RB41, RB42 and RB43 are connected across the respective capacitors C41, C42 and C43. A first bidirectional switch circuit 518 is connected across the capacitor C43 and the capacitor C41. A second bidirectional switch circuit 520 is connected across the capacitor C43 and a capacitor C42. Each of the switch circuits 518 and 520 includes back to back switch pairs. A switch pair Sw41 and Sw45 is connected in series between the input node 504 and the output positive terminal 512. A switch pair Sw46 and Sw42 is connected in series between the junction of the capacitors C41 and C42 and the output return terminal 514. A switch pair Sw43 and Sw47 is connected in series between the junction of the capacitors C41 and C42 and the output positive terminal 512. Finally, the switch pair Sw48 and Sw44 is connected between the input node 506 and the output return terminal 514. Each of the switches comprises an IGBT or other power transistor with an anti-parallel free-wheeling diode. Unlike other configurations, the switches in the buck-boost configuration need to have anti-parallel free-wheeling diodes across them.

The switches Sw41-Sw48 are controlled by a control circuit 522 represented by a front-end logic board.

If the block 508 represents a DC supply and the block 516 a DC load, then the buck-boost converter 500 operates in a buck mode. To operate in a boost mode, the inputs 502 and output 510 are reversed, i.e., the block 516 is the DC supply and the block 508 is the DC load, it being understood that the reference to input and output would then be reversed.

In the topology in FIG. 11, a back to back switch combination is used to achieve bidirectional power flow. If the switch set comprising of Sw41 through Sw44 are activated, the configuration in FIG. 11 works in the buck or step-down mode. On the other hand, if the switch set comprising of Sw45 through Sw48 are activated, the configuration in FIG. 11 works in the boost or step-up mode. The position of the source and the load changes depending on the desired application. For a step-down operating mode, the input source is applied across the second capacitors C41 and C42 in series and the load is across the single first capacitor C43. On the other hand, for a step-up operating mode, the input source is applied across the single first capacitor C43 and the load is connected across the series connected second capacitors C41 and C42.

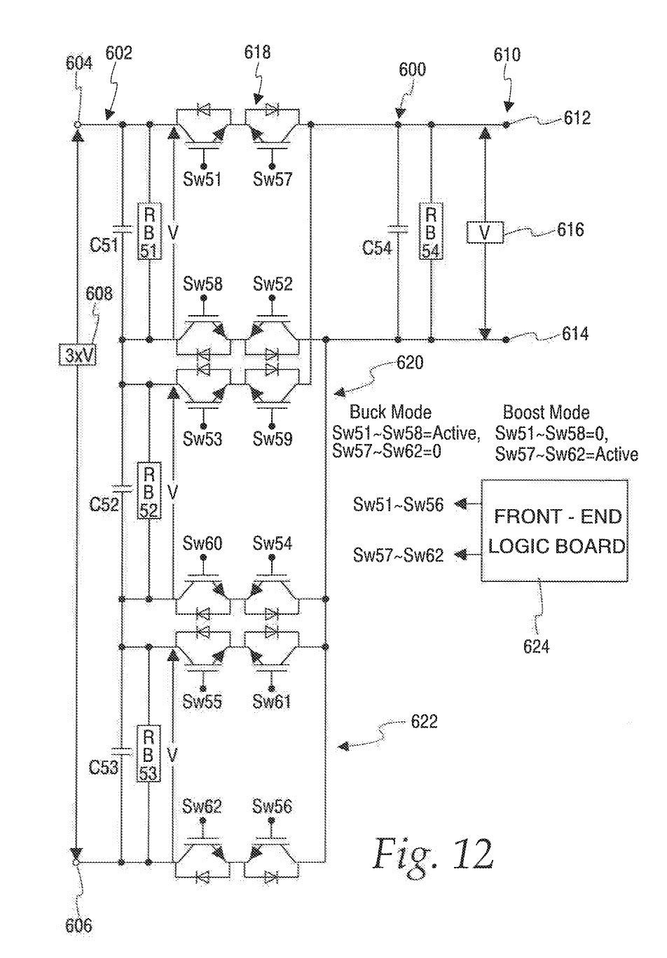

The idea proposed in FIG. 11 can be extended to a configuration that has three sections but as pointed out earlier, due to the high number of switches involved, it may not be economically feasible. FIG. 12 shows a similar configuration that has three sections.

Particularly, FIG. 12 illustrates buck-boost DC to DC converter 600 having an input 602 and an output 610. The overall configuration is generally similar to that shown in FIG. 4, except for the use of bidirectional switching arrangements in the three switch sections 618, 620 and 622, similar to that in FIG. 11. Additional elements are illustrated with similar reference numerals, albeit in the 600 series, as shown, but are not otherwise described in detail as the interconnections are apparent from the schematic of FIG. 12.

The structure shown in FIG. 12 for a buck-boost configuration with three sections has twelve switches. The large number of switches in the configuration shown in FIG. 12 makes it less attractive and perhaps not economically feasible. However, if the power rating of the converter is small, the topology can be adopted.

From the discussions in the preceding sections, the following important features of the proposed switched capacitor scheme are provided. The capacitor switching scheme does not utilize any intermediate energy storage element in the form of a magnetic based component. The capacitor switching scheme is extremely efficient since the switching loss is extremely low due to inductorless topology. Conduction loss forms majority of loss component and the overall stress on all components are the same. The structure does not have any semiconductor device that is rated at the highest input or output voltage. At all times, the voltage across the switch is either half of input voltage or ⅔ of input voltage when there are three sections. In addition, all passive components have the same voltage and current rating. The structure can be configured to behave in the step-down mode of operation or the step-up mode of operation. The structure incorporating back to back switches allow for bidirectional power flow. Depending on the choice of switch set, the configuration can work either in the step-down mode or in the step-up mode.

Unlike other switched capacitor schemes, the described topology does not need feedback to operate. This is because symmetric operation is being provided, resulting in discreet voltage attenuation or gain.

It will be appreciated by those skilled in the art that there are many possible modifications to be made to the specific forms of the features and components of the disclosed embodiments while keeping within the spirit of the concepts disclosed herein. Accordingly, no limitations to the specific forms of the embodiments disclosed herein should be read into the claims unless expressly recited in the claims. Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

The foregoing disclosure of specific embodiments is intended to be illustrative of the broad concepts comprehended by the invention.

1. A DC TO DC converter, comprising:
an input for connection to a DC supply and an output for connection to a DC load;
a first capacitor connected across one of the output and the input;
a plurality of second capacitors connected in series across the other of the input and the output, wherein the first capacitor and the second capacitors are of equal capacitance;
a plurality of switch circuits, one for each second capacitor, each switch circuit is connected across the first capacitor and one of the second capacitors; and
a control circuit controlling operation of the plurality of switch circuits to momentarily place each second capacitor alternately across the first capacitor to transfer energy therebetween to selectively step-down or step-up voltage of the DC supply to the DC load.

2. The DC TO DC converter of claim 1 comprising two second capacitors.

3. The DC TO DC converter of claim 1 comprising three second capacitors.

4. The DC TO DC converter of claim 1 wherein the switch circuits comprise IGBTs.

5. The DC TO DC converter of claim 1 wherein the switch circuits comprise unidirectional switches wherein the control circuit selectively controls the switches to provide one of step-down or step-up configuration.

6. The DC TO DC converter of claim 1 wherein the switch circuits comprise bidirectional switches wherein the control circuit selectively controls the switches to provide both step-down and step-up configuration.

7. A step-down DC TO DC converter, comprising:
an input for connection to a DC supply and an output for connection to a DC load;
a first capacitor connected across the output;
a plurality of second capacitors connected in series across the input, wherein the first capacitor and the second capacitors are of equal capacitance;
a plurality of switch circuits, one for each second capacitor, each switch circuit is connected across the first capacitor and one of the second capacitors; and
a control circuit controlling operation of the plurality of switch circuits to momentarily place each second capacitor alternately across the first capacitor to transfer energy therebetween to step-down voltage of the DC supply to the DC load.

8. The step-down DC TO DC converter of claim 7 comprising two second capacitors to provide ½ step-down configuration.

9. The step-down DC TO DC converter of claim 8 wherein the switch circuits comprise IGBTs with free-wheeling anti-parallel diodes.

10. The step-down DC TO DC converter of claim 7 comprising three second capacitors to provide ⅓ step-down configuration.

11. The step-down DC TO DC converter of claim 10 wherein the switch circuits comprise IGBTs.

12. A step-up DC TO DC converter, comprising:
an input for connection to a DC supply and an output for connection to a DC load;
a first capacitor connected across the input;
a plurality of second capacitors connected in series across the output, wherein the first capacitor and the second capacitors are of equal capacitance;
a plurality of switch circuits, one for each second capacitor, each switch circuit is connected across the first capacitor and one of the second capacitors; and
a control circuit controlling operation of the plurality of switch circuits to momentarily place each second capacitor alternately across the first capacitor to transfer energy therebetween to step-up voltage of the DC supply to the DC load.

13. The step-up DC TO DC converter of claim 12 comprising two second capacitors to provide step-up configuration having a gain of 2.

14. The step-up DC TO DC converter of claim 13 wherein the switch circuits comprise IGBTs with free-wheeling anti-parallel diodes.

15. The step-up DC TO DC converter of claim 12 comprising three second capacitors to provide step-up configuration having a gain of 3.

16. The step-up DC TO DC converter of claim 15 wherein the switch circuits comprise IGBTs.

17. A buck-boost DC TO DC converter, comprising:
an input for connection to one of a DC supply and a DC load and an output for connection to the other of the DC load and the DC supply;
a first capacitor connected across the output;
a plurality of second capacitors connected in series across the input, wherein the first capacitor and the second capacitors are of equal capacitance;
a plurality of bidirectional switch circuits, one for each second capacitor, each bidirectional switch circuit is connected across the first capacitor and one of the second capacitors; and
a control circuit controlling operation of the plurality of bidirectional switch circuits to momentarily place each second capacitor alternately across the first capacitor to transfer energy therebetween to step-up or step-down voltage of the DC supply to the DC load.

18. The buck-boost DC TO DC converter of claim 17 comprising two second capacitors to provide ½ step-down in buck operation or a gain of two in a boost operation.

19. The buck-boost DC TO DC converter of claim 17 comprising three second capacitors to provide ⅓ step-down in buck operation or a gain of three in a boost operation.

20. The buck-boost DC TO DC converter of claim 17 wherein the switch circuits comprise IGBTs.

21. The buck-boost DC TO DC converter of claim 17 wherein each bidirectional switch circuit comprises four switches, each switch comprising an IGBT with a free-wheeling anti-parallel diode
